(19) United States
(12) Patent Application Publication
(10) Pub. No.: US 2022/0166778 A1
(43) Pub. Date: May 26, 2022

(54) APPLICATION WHITELISTING BASED ON FILE HANDLING HISTORY

(71) Applicant: Saudi Arabian Oil Company, Dhahran (SA)

(72) Inventors: Aseel Alomair, Dhahran (SA); Mohammed Mujtaba, Dhahran (SA)

(73) Assignee: Saudi Arabian Oil Company, Dhahran (SA)

(21) Appl. No.: 17/103,286

(22) Filed: Nov. 24, 2020

(51) Int. Cl. H04L 29/06; H04L 9/32

(52) U.S. Cl. CPC H04L 63/101; H04L 9/3239

(57) ABSTRACT

Systems and methods include a identifying, by an electronic device, a file identifier of a file related to a user whitelist request. The electronic device then identifies, based on the file identifier, a frequency of previous whitelist handling of the file and determines, based on that frequency, whether to approve the user whitelist request. The electronic device then outputs an indication of whether the user whitelist request is approved. Other embodiments may be described or claimed.

### TECHNICAL FIELD

The present disclosure applies to application whitelisting based on prior file handling history.

### BACKGROUND

In an organization with a large number of users, it may be difficult or time consuming to evaluate every new application approval request that is related to whitelisting an application. As used herein, “whitelisting” refers to authorization to install or use an application on a computing device that is part of the organization's network or computing system.

### SUMMARY

The present disclosure describes techniques that can be used for addressing application whitelisting within an organization. Specifically, embodiments herein relate to techniques that may be used for analyzing or operating an application approval process for newly requested application whitelisting approval requests. In embodiments, the technique includes collecting file information from a user whitelist request, and then comparing that file information to historical data related to a whitelisting approval process. Once the comparison is processed, an approval or redetection decision may be made and implemented by the process. Such a decision may include approval of the file such that the file may be installed on a user's machine or other used by the user within the organization's computing system. Another such decision may include no approving the file such that the file may not be used or installed. If the comparison is un-successful, for example because there is not enough information related to the file in the historical data, then information related to the file may be re-reviewed to identify whether the application should be whitelisted.

In some implementations, a computer-implemented method includes: identifying a file identifier of a file related to a user whitelist request; identifying, based on the file identifier, a frequency of previous whitelist handling of the file; determining, based on the frequency of the previous whitelist handling of the file, whether to approve the user whitelist request; and outputting, based on the determination of the frequency of the previous whitelist approval of the file, an indication of whether the user whitelist request is approved.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize a variety of advantages. For example, a large organization may include a very high number (e.g., on the order of thousands) of connected systems. In this organization, a quick and accurate response to a user whitelist solution that maintains information security may be desirable, but very hard to implement. Embodiments herein reduce the amount of work that needs to be done on by an analyst on a whitelist approval request by providing a solution in which files or applications may be automatically approved for use without requiring processing or analysis by a human. As such, efficiency and accuracy of such analysis may be significantly increased.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 depicts an example system that is configured to perform an application whitelisting technique based on a previous handling history, in accordance with various embodiments.

FIG. 2 depicts an example application whitelisting technique based on a previous handling history, in accordance with various embodiments.

FIG. 3 depicts an alternative example application whitelisting technique based on a previous handling history, in accordance with various embodiments.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for application whitelisting approval based on previous handling of the file. As used herein, the term “handled” or “handling” relates to an occurrence of the file being reviewed or analyzed, and then being the subject of an approval decision as described herein.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

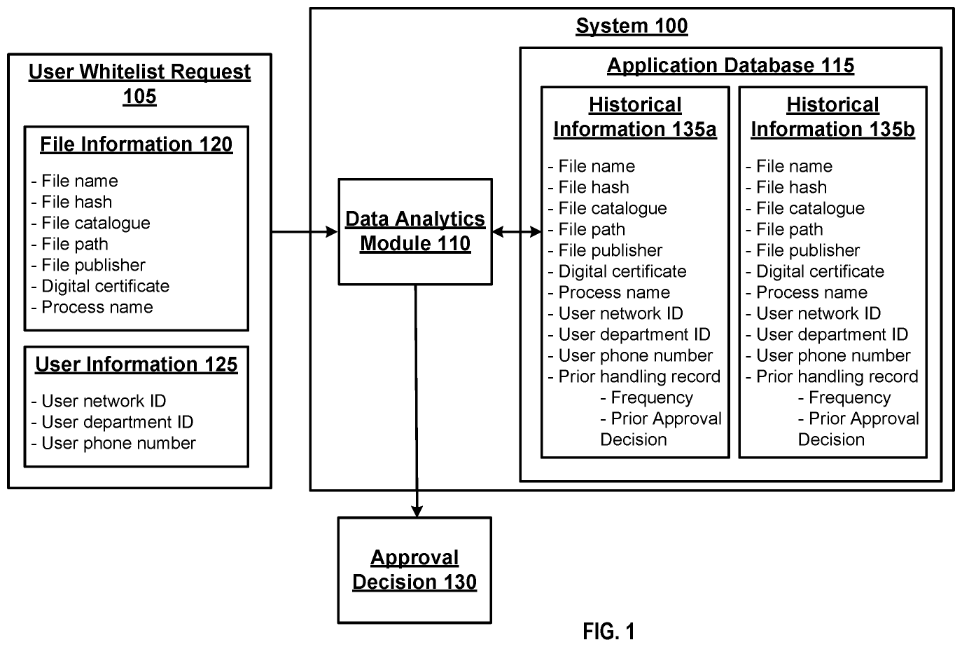

FIG. 1 depicts an example system 100 that is configured to perform an application whitelisting technique based on a previous handling history, in accordance with various embodiments. The system 100 includes a data analytics module 110 and an application database 115. It will be understood that although the system 100 is depicted as a single element, in some embodiments the system 100 may include a plurality of physical elements. For example, the data analytics module 110 may be implemented on one processor, processor core, circuit board, electronic device, etc., and the application database 115 may be implemented on a different processor, processor core, circuit board, electronic device, etc. In another embodiment, the data analytics module 110 and the application database 115 may be implemented on the same processor, processor core, circuit board, electronic device, etc., as depicted in FIG. 1.

The system 100 may receive a user whitelist request at 105. The user whitelist request 105 may be a request by the user to approve a program or file for use by the user. Specifically, the request at 105 may be a request for installation of a file, access of a file, use of a file, etc. on a computing device that is an element of an organization's network. In one embodiment, the user whitelist request 105 may be input directly to the system 100 by a user (e.g., through an input device such as a keyboard, a mouse, or some other input device.) In another embodiment, the user whitelist request 105 may be input by the user to another electronic device (e.g., the electronic device on which the file is to be run or accessed), and then the request is provided to the system 100 over a wireless or wired connection.

The user whitelist request 105 may include one or both of file information 120 and user information 125 related to the user that initiated the request. The file information 120 may include elements such as:
A file name of the file;
A file hash that is a hash value based on or otherwise related to the file. The hash value may be based on a hashing algorithm such as a Merkle-Damgard (MD) hash function such as MD5, a 256-bit secure-hash algorithm (SHA256), or some other algorithm;
A file catalogue which is a database of some or all of the existing files in the organization. The file catalogue may be maintained by an application whitelisting system. In various embodiments, the file catalogue may be indexed based on one or more of a hash value, file name, location of the computer, etc.;
A file path which may include an indication of one or more servers, computers, directories, sub-directories, etc. in which the file is located;
A file publisher which is an indication of a publisher or generator of the file. For example, the file publisher may refer to a company or entity that created the file. In another embodiment, the file publisher may refer to a program that generates the file based on one or more other inputs;
A digital certificate related to the file. The digital certificate may be, for example, a has value provided by the file publisher which may serve to authenticate that the file has not been tampered with or altered in some way; and
A process name of a process that is to run or otherwise interact with the file.

The user information 125 may include such elements as:
A user network identifier (ID). The user network ID may be, for example, an email address of the user, a network login of the user, or some other ID;
A user department ID which, for example, signifies a department in which the user works. The department may be organized by a group of people on a team within the organization, a physical location, etc.; and
A user phone number. The user phone number may be related to the user's home phone, work phone, mobile phone, etc.

It will be understood that the above-described elements of the file information 120 and the user information 125 are intended as examples of elements of the described information, and in other embodiments the file information 120 or the user information 125 may include more or fewer elements than discussed or described above. Further, it will be understood that the depiction in FIG. 1 is intended as a high-level example depiction for the sake of discussion herein, and is not intended to depict the specific organization of the information within the whitelist request 105. For example, the elements of the file information 120 or the user information 125 may be organized in a table that is appended to the request, a machine-parsable spreadsheet, an information element, etc. The file information 120 and the user information 125 may not be organized separately from one another, but may be combined into a single information element or table.

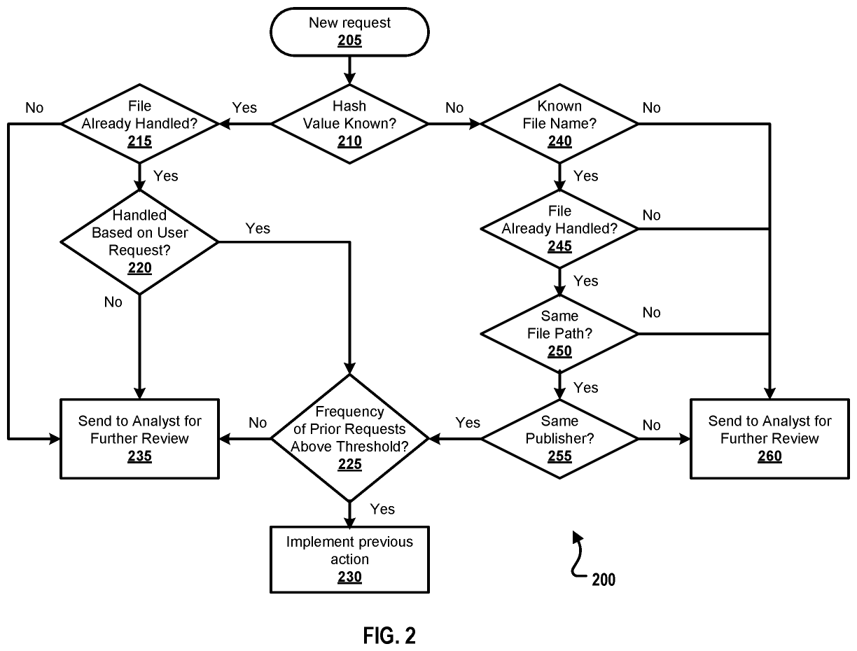

The user whitelist request 105 may be received and processed by the data analytics module 110. The data analytics module 110 may be implemented on one or more processors, processor cores, etc. The data analytics module 110 may be configured to review and process the user whitelist request as will be described in more detail below with respect to FIG. 2. For example, the data analytics module 110 may be configured to compare information related to the user whitelist request 105 (e.g., the file information 120 or the user information 125) with information in an application database 115.

The application database 115 may include historical information such as historical information 135a and 135b (collectively referred to as “historical information 135”). The historical information 135a and 135b may, include information related to previous whitelist approvals or denials. Similarly to the file information 120 or user information 125, the historical information 135a and 135b may be organized as a table, a machine-parsable spreadsheet, an information element, etc. As may be seen, the application database 115 may include a number of historical information records such as historical information 135a and 135b. Although only two historical information 135 records are shown in FIG. 1, the application database 115 may include more or fewer. Generally, each of the historical information 135 records relate to a different file, and may be organized or searchable in accordance with one or more of the fields to which the historical information 135 records pertain.

The historical information 135a and 135b may include information that includes or is related to a file name, file hash, file catalogue, file path, file publisher, digital certificate, process name, user network ID, user department ID, user phone number, etc. The historical information 135a and 135b may further include information related to a prior handling record. The prior handling record may include, for example, an indication of the frequency with which the record has been reviewed, and what the outcome of such review was (e.g., the prior approval decision). The frequency and prior approval decision will be described in greater detail with respect to FIG. 2.

In operation, the data analytics module 110 may be configured to store information related to the user whitelist request in the application database 115 (i.e., to create a new historical information 135 record). The data analytics module 110 may also be configured to compare one or more elements of the user whitelist request 105 (e.g., an element of the file information 120 and/or the user information 125) with elements of the historical information 135. If the data analytics module 110 is able to find a match between the user whitelist request 105 and an element of the historical information 135 in the application database, the data analytics module 110 may identify the prior handling record which pertains to the file that is the subject of the user whitelist request 105. Based on the prior handling record of the historical information (e.g., historical information 135a or 135b), the data analytics module 110 may identify an approval decision 130, which may then be output.

The output of the approval decision 130 may take a variety of forms. One such form may be that the file which is the subject of the user whitelist request 105 is disapproved, and the user is barred from accessing, using, modifying, or installing the file (or some other action related to the file). Alternatively, the form may be that the file which is the subject of the user whitelist request 105 is approved and the user is allowed to access, modify, use, install, etc. the file. These alternatives may occur if, for example, the frequency related to the prior handling record is at or above a pre-identified frequency threshold such that the approval (or disapproval) of the file related to the user whitelist request 105 is in accordance with prior actions taken in relation to the file.

In another embodiment, the frequency related to the file as identified in the prior handling record may be at or below the pre-identified frequency threshold. In this embodiment, the system may be unable to determine previous actions taken in regard to the file that is the subject of the user whitelist request 105, and so information related to the file may be forwarded to a secondary review. The secondary review may be, for example, performed by a human analyst (e.g., a member of the organizations information technology (IT) department), a machine-operated algorithm, etc.

It will be recognized that these actions that are described with respect to the approval decision 130 are intended as example actions, and other actions may be possible in other embodiments. It will also be recognized that the depiction of the elements of the user whitelist request 105 and the historical information 135 are intended as example depictions. In some embodiments, the file information 120 and the user information 125 may not be separated from one another, but rather may be a single record (or part of a single record). Additionally or alternatively, the historical information 135a and 135b may not be a single record, but rather may be separated (such as is shown with respect to the file information 120 or the user information 125). In some embodiments, more or fewer elements may be present than are depicted in FIG. 1, or the elements may be arranged in a different order. Other variations may be present.

FIG. 2 depicts an example application whitelisting technique 200 based on a previous handling history, in accordance with various embodiments. Generally, the technique may be performed by the system 100 and, more specifically, the data analytics module 110.

The technique may start with identification, at 205 by the system 100 and, more specifically, the data analytics module 110, of a new request. The request at 205 may be similar to, for example, the user whitelist request 105.

The system 100 may then compare a number of file identifiers from the user whitelist request to historical information such as historical information 135 of the application database 115. For example, the system may initially determine, at 210, whether the user whitelist request includes a known has value (e.g., the file has described with respect to file information 120). More specifically, the system may determine, at 210, whether the application database 115 includes historical information 135 that includes a matching file hash.

If the hash value is known, then the system may identify, at 215, whether the file that is the subject of the user whitelist request 105 has previously been handled or reviewed. This identification may be based on, for example, information in the prior handling record of historical information 135 of the application database.

If the file has been previously handled, then the system may identify, at 220, whether the prior handling/review was based on a user request. This identification may be based on, for example, information in the prior handling record such as a flag or other indicator which indicates that the prior handling was based on a user request. Additionally or alternatively, the identification of the prior handling/review may be based on information such as the user network ID, the user department ID, a user phone number, or some other identifier associated with a user which may indicate that the prior handling is related to a user or a previous user request.

If it is determined at element 215 that the file has not been handled, or if it is determined at 220 that the prior handling was not based on a user request, then the user whitelist request 105 may be sent to an analyst for further review at 235. In some embodiments, the analyst may be a human analyst such as a member of an organization's IT team, a member of an organization's information security team, or some other analyst. Additionally or alternatively, the analyst may be another program or algorithm that is capable of analyzing the user whitelist request 105.

However, if it is determined at 220 that the prior handling was based on a user request, then the system may determine, at 225, whether the frequency of prior requests is above a threshold. It will be understood that although the relation of “above” is described herein, in other embodiments the relation may be “at or above.” Similarly, dependent on the specific factor that is being compared, and how the comparison is structured, the comparison may be “below” or “at or below.” Generally, the term “above” will be used herein, and it will be understood that the concepts described herein may be implemented in a variety of ways to verify that sufficient number of previous handlings have occurred, and the specific mathematical function is beyond the scope of this discussion.

Generally, the system may determine, at 225, the frequency of prior requests related to the file that is the subject of the user whitelist request 105 using, for example, the prior handling record in the historical information 135 that is related to the file. In some embodiments, the comparison may be based on a pre-identified condition such as a number of frequencies with different timespans and different occurrences. For example, in one embodiment the system may identify whether the file has been the subject of 10 or more user whitelist requests in a week, 20 or more user whitelist requests in a month, or 60 or more user whitelist requests in a year. Other embodiments may have more or fewer threshold criteria, different frequencies or timespans, etc. Other embodiments may use a dynamic threshold or some other type of threshold that is based on, for example, factors related to the file, factors related to the file (e.g., a trusted user may be provided with a lower threshold than an untrusted user; a trusted publisher may be provided with a lower threshold than an untrusted publisher, etc.), or some other factor.

If the system identifies at 225 that the frequency of prior requests is not above the threshold at 225, then the file may be forwarded to an analyst for further review at 235 as described above. However, if the system identifies at 225 that the frequency of the prior requests is above a threshold, then the system may identify and implement, at 230, a previous action related to the file. For example, if the prior handling record of the historical information 135, and particularly the prior approval decision, indicates that the file was approved, then the file may be whitelisted and the user may be given permissions to install/use/access/modify/etc. the file. Alternatively, if the prior handling record of the historical information 135, and particularly the prior approval decision, indicates that the file was not approved, then the user may be prohibited from installing/using/accessing/modifying/etc. the file.

Returning to element 210, if the system is unable to match the user whitelist request 105 with a historical information 135 record at 210, then the system may attempt to match the file that is the subject of the user whitelist request 105 with historical information 135 based on a different file identifier. Specifically, the system may identify, at 240, whether the file can be identified based on the file name of the file as indicated, for example, in the “file name” element of the file information 120 of the user whitelist request 105.

The system may then check at 245 whether the file has previously been handled. This check may be similar to, for example, element 215 and will not be re-iterated here for the sake of clarity of this disclosure.

If the file is identified at 245 as having previously been handled, it may be desirable to perform one or more additional checks as depicted in FIG. 2. Specifically, the hash value identified at 210 may help to verify that the file has not been tampered with or otherwise altered since it had previously been handled or reviewed. However, if the hash is unavailable, the file may have the same name, but may not in actuality have the same contents or data, or the data may have been tampered with or altered in some way (e.g., through the addition of malware or a case of different files having the same name).

To remedy this uncertainty, additional checks such as those described at elements 250 and 255 may be performed. Specifically, the system may identify, at 250, whether the file has the same file path. This verification may be based on a comparison of the listed file path element of the user whitelist request 105 with the file path element of the historical information 135. The system may further identify, at 255, whether the file that is the subject of the user whitelist request 105 has a same publisher (e.g., the same publisher name, publisher certificate, etc.) as a file in the historical information with the same name. This verification may be based on a comparison of information related to the file publisher in the user whitelist request 105 with the information related to the file publisher in the historical information 135.

As may be seen, if the file passes the checks at elements 240, 245, 250, and 255, then the technique 200 may proceed to element 225 as described above. However, if the file fails one or more of the checks at elements 240, 245, 250, and 255, then the file may be sent to an analyst for further review at 260, which may be similar to element 235 as described above.

The technique 200 of FIG. 2 provides numerous advantages as described above. One such advantage is that a file whitelist request may be quickly handled by a system such as system 100 based on a previous record associated with that file. More specifically, the file may be handled without the need for a human to review the file, which may increase the efficiency and speed with which whitelist requests may be processed. Additionally, by allowing for different frequency numbers and timelines at 225, the system may provide flexibility in reviewing the user whitelist request. Other advantages may be apparent to one of skill in the art.

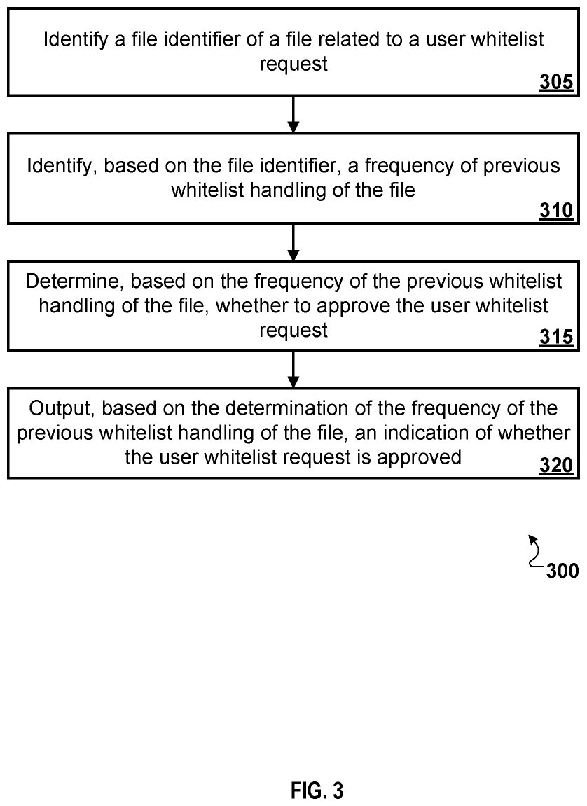

FIG. 3 depicts an alternative example application whitelisting technique 300 based on a previous handling history, in accordance with various embodiments. Generally, the technique may be performed by a system such as system 100 and, more specifically, a data analytics module 110 of system 100.

The technique may include identifying, at 305, a file identifier of a file related to a user whitelist request. The file identifier may be, for example, the hash value described with respect to element 210, the file name described with respect to element 240, the file path described with respect to element 250, the publisher described with respect to element 255, or some other file identifier.

The technique 300 may further include identifying, at 310 based on the file identifier, a frequency of previous whitelist handling of the file. The frequency may be, for example, the frequency described with respect to element 225.

The technique 300 may further include determining, at 315 based on the frequency of the previous whitelist handling of the file, whether to approve the user whitelist request. This determination may be similar to the determination described above with respect to element 225. Specifically, if the frequency of handlings is above a threshold, then the system may perform a previous action related to the file such as whitelist approval or disapproval. If the frequency of handlings is below the threshold, then the system may forward the file to an analyst for further review. As described above, the threshold may be dynamic or pre-identified. In other embodiments, dependent on how the comparison is structured, the comparison may be based on “at or above,” “below,” or “at or below.”

The technique 300 may further include outputting, at 320 based on the determination of the frequency of the previous whitelist handling of the file, an indication of whether the user whitelist request is approved. This outputting may be or include automatically approving the file such that a user is given permissions to use/install/modify/access/etc. the file. In another embodiment, the outputting may be or include automatically disapproving the file such that the user is prohibited from using/installing/modifying/accessing/etc. the file. In another embodiment, the outputting may include forwarding the file to an analyst for further review. In another embodiment, the outputting may include providing a visual output on a display, an audio output, etc. to inform the user of the outcome of the review of the user whitelist request.

It will be understood that the above-described techniques 200 and 300 of FIGS. 2 and 3 are intended as high-level examples. Techniques of other embodiments may include more or fewer elements than are depicted, or elements in a different order than depicted. Other variations may be present in other embodiments.

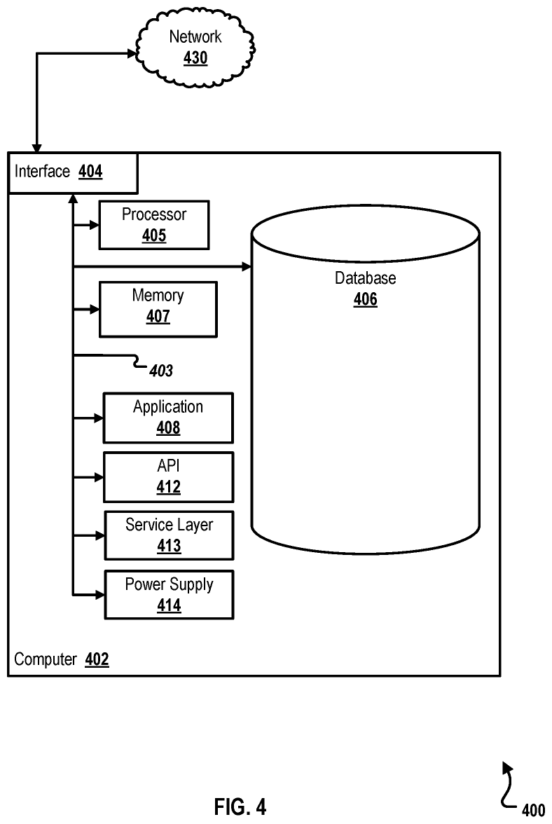

FIG. 4 is a block diagram of an example computer system 400 used to provide computational functionalities associated with described algorithms, methods, functions, processes, flows, and procedures described in the present disclosure, according to some implementations of the present disclosure. For example, system 100 may be, or may be implemented on, computer system 400. More specifically, the data analytics module 110 may be implemented on processor 405. The application database 115 may be implemented on one or both of database 406 or memory 407. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or graphical user interface (GUI)).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a top level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both) over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, one or more non-transitory computer-readable media include instructions that, upon execution of the instructions by one or more processors of an electronic device, are to cause the electronic device to: identify a file identifier of a file related to a user whitelist request; identify, based on the file identifier, a frequency of previous whitelist handling of the file; determine, based on the frequency of the previous whitelist handling of the file, whether to approve the user whitelist request; and output, based on the determination of the frequency of the previous whitelist handling of the file, an indication of whether the user whitelist request is approved.

The foregoing and other described implementations can each, optionally, include one or more of the following features:

A first feature, combinable with one or more other features or embodiments described herein, wherein the file identifier is a hash value related to the file.

A second feature, combinable with one or more other features or embodiments described herein, wherein the file identifier is a file name of the file.

A third feature, combinable with one or more other features or embodiments described herein, wherein the file identifier is a file path related to the file.

A fourth feature, combinable with one or more other features or embodiments described herein, wherein the file identifier is an identifier of a publisher of the file.

A fifth feature, combinable with one or more other features or embodiments described herein, wherein the instructions are further to identify, based on the file identifier, that a previous whitelist handling of the file was based on a user request.

A sixth feature, combinable with one or more other features or embodiments described herein, wherein the indication is an indication that the file is whitelisted and is approved for use by a user or installation on a computing device.

A seventh feature, combinable with one or more other features or embodiments described herein, wherein the indication is an indication that the file is not whitelisted and is to be further reviewed prior to use by a user or installation on a computing device.

An eighth feature, combinable with one or more other features or embodiments described herein, wherein the frequency is based on one of a first number of handlings of the file in a first timespan and a second number of handlings of the file in a second timespan.

A ninth feature, combinable with one or more other features or embodiments described herein, wherein the first number of handlings is greater than the second number of handlings, and the first timespan is longer than the second timespan.

In a second implementation, an electronic device includes: one or more processors; and one or more non-transitory computer-readable media comprising instructions that, upon execution of the instructions by the one or more processors of an electronic device, are to cause the electronic device to: identify a file identifier of a file related to a user whitelist request; identify, based on the file identifier, a frequency of previous whitelist handlings of the file; determine, based on the frequency of the previous whitelist handlings of the file, whether to approve the user whitelist request, wherein the frequency is based on one of a first number of previous whitelist handlings in a first timespan and a second number of previous whitelist handlings in a second timespan; and output, based on the determination of the frequency of the previous whitelist handlings of the file, an indication of whether the user whitelist request is approved.

The foregoing and other described implementations can each, optionally, include one or more of the following features:

A first feature, combinable with one or more other features or embodiments described herein, wherein the file identifier is a hash value related to the file, a file name of the file, a file path related to the file, or an identifier of a publisher of the file.

A second feature, combinable with one or more other features or embodiments described herein, wherein the instructions are further to identify, based on the file identifier, that a previous whitelist handling was based on a user request.

A third feature, combinable with one or more other features or embodiments described herein, wherein the indication is an indication that the file is whitelisted and is approved for use by a user or installation on a computing device.

A fourth feature, combinable with one or more other features or embodiments described herein, wherein the first number of previous whitelist handlings is a higher number than the second number of previous whitelist handlings, and the first timespan is greater than the second timespan.

In a third implementation, a method includes: identifying, by one or more processors of an electronic device based on a file identifier of a file related to a user whitelist request, a frequency of previous whitelist handlings of the file; determining, by the one or more processors based on the frequency of the previous whitelist handlings of the file, whether to approve the user whitelist request; and outputting, by the one or more processors based on the determination of the frequency of the previous whitelist handlings of the file, an indication of whether the user whitelist request is approved.

The foregoing and other described implementations can each, optionally, include one or more of the following features:

A first feature, combinable with one or more other features or embodiments described herein, wherein the file identifier is a hash value related to the file, a file name of the file, a file path related to the file, or an identifier of a publisher of the file.

A second feature, combinable with one or more other features or embodiments described herein, wherein the method further comprises identifying, by the one or more processors based on the file identifier, that a previous whitelist handling was based on a user request.

A third feature, combinable with one or more other features or embodiments described herein, wherein the indication is an indication that the file is whitelisted and is approved for use by a user or installation on a computing device.

A fourth feature, combinable with one or more other features or embodiments described herein, wherein the frequency is based on one of a first number of approvals in a first timespan and a second number of approvals in a second timespan.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more GUIs and each of the displays of a particular GUI. Therefore, a GUI can represent any GUI, including, but not limited to, a web browser, a touch screen, or a command line interface (CLI) that processes information and efficiently presents the information results to the user. In general, a GUI can include a plurality of UI elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. One or more non-transitory computer-readable media comprising instructions that, upon execution of the instructions by one or more processors of an electronic device, are to cause the electronic device to:
identify a file identifier of a file related to a user whitelist request;
identify, based on the file identifier, a frequency of previous whitelist handling of the file;
determine, based on the frequency of the previous whitelist handling of the file, whether to approve the user whitelist request; and
output, based on the determination of the frequency of the previous whitelist handling of the file, an indication of whether the user whitelist request is approved.

2. The one or more non-transitory computer-readable media of claim 1, wherein the file identifier is a hash value related to the file.

3. The one or more non-transitory computer-readable media of claim 1, wherein the file identifier is a file name of the file.

4. The one or more non-transitory computer-readable media of claim 1, wherein the file identifier is a file path related to the file.

5. The one or more non-transitory computer-readable media of claim 1, wherein the file identifier is an identifier of a publisher of the file.

6. The one or more non-transitory computer-readable media of claim 1, wherein the instructions are further to identify, based on the file identifier, that a previous whitelist handling of the file was based on a user request.

7. The one or more non-transitory computer-readable media of claim 1, wherein the indication is an indication that the file is whitelisted and is approved for use by a user or installation on a computing device.

8. The one or more non-transitory computer-readable media of claim 1, wherein the indication is an indication that the file is not whitelisted and is to be further reviewed prior to use by a user or installation on a computing device.

9. The one or more non-transitory computer-readable media of claim 1, wherein the frequency is based on one of a first number of handlings of the file in a first timespan and a second number of handlings of the file in a second timespan.

10. The one or more non-transitory computer-readable media of claim 9, wherein the first number of handlings is greater than the second number of handlings, and the first timespan is longer than the second timespan.

11. An electronic device comprising:
one or more processors; and
one or more non-transitory computer-readable media comprising instructions that, upon execution of the instructions by the one or more processors of an electronic device, are to cause the electronic device to:
identify a file identifier of a file related to a user whitelist request;
identify, based on the file identifier, a frequency of previous whitelist handlings of the file;
determine, based on the frequency of the previous whitelist handlings of the file, whether to approve the user whitelist request, wherein the frequency is based on one of a first number of previous whitelist handlings in a first timespan and a second number of previous whitelist handlings in a second timespan; and
output, based on the determination of the frequency of the previous whitelist handlings of the file, an indication of whether the user whitelist request is approved.

12. The electronic device of claim 11, wherein the file identifier is a hash value related to the file, a file name of the file, a file path related to the file, or an identifier of a publisher of the file.

13. The electronic device of claim 11, wherein the instructions are further to identify, based on the file identifier, that a previous whitelist handling was based on a user request.

14. The electronic device of claim 11, wherein the indication is an indication that the file is whitelisted and is approved for use by a user or installation on a computing device.

15. The electronic device of claim 11, wherein the first number of previous whitelist handlings is a higher number than the second number of previous whitelist handlings, and the first timespan is greater than the second timespan.

16. A method comprising:
identifying, by one or more processors of an electronic device based on a file identifier of a file related to a user whitelist request, a frequency of previous whitelist handlings of the file;
determining, by the one or more processors based on the frequency of the previous whitelist handlings of the file, whether to approve the user whitelist request; and
outputting, by the one or more processors based on the determination of the frequency of the previous whitelist handlings of the file, an indication of whether the user whitelist request is approved.

17. The method of claim 16, wherein the file identifier is a hash value related to the file, a file name of the file, a file path related to the file, or an identifier of a publisher of the file.

18. The method of claim 16, wherein the method further comprises identifying, by the one or more processors based on the file identifier, that a previous whitelist handling was based on a user request.

19. The method of claim 16, wherein the indication is an indication that the file is whitelisted and is approved for use by a user or installation on a computing device.

20. The method of claim 16, wherein the frequency is based on one of a first number of approvals in a first timespan and a second number of approvals in a second timespan.
